(19) United States
(12) Patent Application Publication
(10) Pub. No.: US 2014/0178121 A1
(43) Pub. Date: Jun. 26, 2014

(54) LEVER-TYPE CONNECTOR

(71) Applicant: Jun Kamiya, Makinohara-shi (JP)

(72) Inventor: Jun Kamiya, Makinohara-shi (JP)

(73) Assignee: YAZAKI CORPORATION, Tokyo (JP)

(21) Appl. No.: 14/234,427

(22) PCT Filed: Jul. 20, 2012
(86) PCT No.: PCT/JP2012/069069

§ 371 Date: Jan. 23, 2014

(30) Foreign Application Priority Data
Jul. 25, 2011 (JP) 2011-162467

(51) Int. Cl. H01R 13/629

(52) U.S. Cl. CPC H01R 13/629
USPC 403/33

(57) ABSTRACT

A lever-type connector includes a housing body, a fitting operation lever including a rotation operation portion and a lever bodies, and a lock portion. An urging arm is provided in the lever-type connector. The urging arm is elastically deformed so as to abut against the lock portion in a fitting completion position. The lock portion includes an elastic arm portion extended from the housing body to the fitting completion position and an engaging portion provided on the elastic arm portion and configured to engage with the rotation operation portion at the fitting completion position. An initial shape of the elastic arm portion is set so that the elastic arm portion is deformed so as to put the engaging portion and the rotation operation portion into a pressure-contact state in a state where the rotation operation portion engages the engaging portion.

### TECHNICAL FIELD

The present invention is related to a lever-type connector in which a housing body is fittingly connected to a mating connector housing through a turning operation of a fitting operation lever equipped in the housing body.

### BACKGROUND ART

FIGS. 8 and 9 each illustrate a conventional lever-type connector.

This lever-type connector 1 is disclosed in PTL 1 described below.

This lever-type connector 1 has a housing body 3 to be fittingly connected to a mating connector housing 2 (see FIG. 9), a fitting operation lever 5 turnably attached to both outer side surfaces of the housing body 3, and a lock portion 7 formed integrally with the housing body 3.

The fitting operation lever 5 has a rotation operation portion 11 extending in the width direction (i.e., the direction of arrow X1 shown in FIG. 8) of the housing body 3, and a pair of lever bodies 12 respectively extending from both ends of the rotation operation portion 11. The pair of lever bodies 12 are turnably and respectively connected to both side surfaces of the housing body 3 by being fitted to lever connecting pins 14 which are respectively provided on both outer surfaces of the housing body 3 to protrude therefrom. The fitting operation lever 5 can be operated to turn from a fitting starting position (i.e., a position illustrated in FIG. 8) to a fitting completion position (i.e., a position illustrated in FIG. 9).

Cam grooves 17 are formed on the lever body 12 by notching, each of which an associated one of connecting-bosses 16 respectively provided on both outer side surfaces of the mating connector housing 2 to protrude therefrom can enter. The cam grooves 17 are formed such that when the fitting operation lever 5 is at a fitting starting position illustrated in FIG. 8, each of the connecting bosses 16 enters the starting end of an associated one of the cam grooves 17, and that, in addition, when the fitting operation lever 5 is operated to turn to the fitting completion position illustrated in FIG. 9, each of the connecting bosses 16 is drawn into the terminating end of an associated one of the cam grooves 17, with the progress of turning of the fitting operation lever 5.

The lock portion 7 is provided on the rear-end-side top surface of the housing body 3 to protrude therefrom. The lock portion 7 has a retaining portion 7a engaging an engaging portion 18 formed at a central part of the rotation operation portion 11. When the fitting operation lever 5 is moved to the fitting completion position, the lock portion 7 retains the engaging portion 18 of the rotation operation portion 11 with the retaining portion 7a to thereby lock the fitting operation lever 5 at the fitting completion position.

In the case of the lever-type connector 1 disclosed in PTL 1, the lock portion 7 does not completely fix the fitting operation lever 5 and allows slight backlash of the fitting operation lever 5. Thus, in order to prevent the fitting operation lever 5 from rattling due to the influence of external vibrations, the lever-type connector 1 disclosed in PTL 1 is equipped with backlash preventing raised-portions 19 as backlash preventing structures.

The backlash preventing raised portions 19 are respectively formed on flat portions on both sides of the engaging portion 18 in the rotation operation portion 11 to be raised therefrom. Each of the backlash preventing raised-portions 19 prevents backlash by abutting, when the rotation operation portion 11 is retained by the lock portion 7, against an opposing surface formed on the lock portion 7.

### CITATION LIST

### Patent Literature

[PTL 1] JP-A-2003-36927

### SUMMARY OF INVENTION

### Technical Problem

In the case of the lever-type connector 1 disclosed in PTL 1, each of the backlash preventing raised-portions 19 has a protruding shape whose raised height is fixed.

Thus, variation occurs in a contact pressure generated between an opposing surface formed on the lock portion 7 and each of the backlash preventing raised-portions 19 due to the forming error (dimension error) of each of the housing body 3 and the fitting operation lever 5, and the assembly error of such components. This causes increase of a fitting operation force. Thus, there has been a problem that it is difficult to assure stable fitting operability.

It is therefore one advantageous aspect of the present invention to provide a lever-type connector capable of preventing backlash of a lever, and reducing the variation of the fitting operation force generated due to the forming error and the assembly error, thereby assuring the stable fitting operability.

### Solution to Problem

According to one advantage of the invention, there is provided a lever-type connector comprising:

a housing body configured to be connected to a mating connector housing;

a fitting operation lever including a rotation operation portion which extends in a width direction of the housing body, and lever bodies which respectively extend from both ends of the rotation operation portion and are connected to both outer side surfaces of the housing body so as to turn with respect to the housing body, wherein the fitting operation lever is configured to be moved from a fitting starting position to a fitting completion position;

a lock portion, provided on the housing body to protrude therefrom, and configured to engage with the rotation operation portion so as to fix the fitting operation lever in a state where the fitting operation lever is positioned at the fitting completion position; and

an urging arm configured to be elastically deformed so as to abut against the lock portion in the state where the fitting operation lever is positioned at the fitting completion position, so that a load is applied to the rotation operation portion in a direction of returning the fitting operation lever to the fitting starting position,

wherein the lock portion includes an elastic arm portion which is extended from an outer surface of the housing body toward an arrival position where the rotation operation portion reaches when the fitting operation lever is moved to the fitting completion position and an engaging portion which is provided on the elastic arm portion and is configured to engage with the rotation operation portion positioned at the arrival position so as to restrict movement of the rotation operation portion, and

wherein an initial shape of the elastic arm portion is set so that the elastic arm portion is deformed so as to put the engaging portion and the rotation operation portion into a pressure-contact state in a state where the rotation operation portion engages the engaging portion.

### Advantageous Effects of Invention

After the position of a mating connector housing is adjusted to the fitting starting position at which fitting the mating connector housing to the housing body is started, the fitting operation lever is turned from the fitting starting position to the fitting completion position, so that fitting the housings to each other is completed. Then, the fitting operation lever moved to the fitting completion position is locked by engaging the rotation operation portion and the engaging portion of the lock portion.

When the rotation operation portion of the fitting operation lever engages the engaging portion of the lock portion, the elastic arm portion which supports the engaging portion is flexural deformed, so that the engaging portion and the rotation operation portion are brought into a pressure-contact state. The flexural deformation of the elastic arm portion, which puts the engaging portion and the rotation operation portion into a pressure-contact state, not only maintains the pressure-contact state of the engaging portion and the rotation operation portion but absorbs the forming error (dimension error) of each of the housing body and the fitting operation lever and the assembly error of such components to thereby reduce variation of a fitting operation force generated due to the forming error and the assembly error of each component.

With the above configuration, when the fitting operation lever is moved to the fitting completion position to thereby retain the rotation operation portion at the engaging portion of the lock portion, the urging arm equipped in the rotation operation portion is elastically deformed by the abutment of the rotation operation portion against a surface of the lock portion. Thus, a load in a direction of returning the fitting operation lever to the fitting starting position is caused to act upon the rotation operation portion.

When the engaging portion and the rotation operation portion are in a pressure-contact state, the load given by the urging arm to the rotation operation portion acts in a direction of enhancing the pressure-contact between the engaging portion and the rotation operation portion, prevents a pressure-contact force acting between the engaging portion and the rotation operation portion, which is generated due to the forming error and the assembly error of each component, from becoming insufficient, and stabilizes the locking of the rotation operation portion by the engaging portion.

That is, the flexural deformation of the elastic arm portion, and the elastic deformation of the urging arm absorb the forming error (dimension error) of each of the housing body and the fitting operation lever, and the assembly error of these components, and reduce the variation of the fitting operation force generated due to the forming error and the assembly error of each component. Accordingly, stable fitting operability can be assured.

In addition, when the engagement between the engaging portion and the rotation operation portion is released by an unlocking operation, the load given by the urging arm to the rotation operation portion pushes the fitting operation lever back to the fitting starting position side. Thus, an operation of releasing the housing body from a mating connector housing can be facilitated. Consequently, treatability can be enhanced.

In accordance with the lever-type connector according to the invention, when the fitting operation lever is moved to the fitting completion position, so that the rotation operation portion of the fitting operation lever is locked to the engaging portion of the lock portion, the elastic arm portion which supports the engaging portion is flexurally deformed. Thus, the engaging portion and the rotation operation portion are brought into a pressure-contact state. In addition, the urging arm equipped in the rotation operation portion is elastically deformed to thereby prevent a pressure-contact force acting between the engaging portion and the rotation operation portion from becoming insufficient. Consequently, the locking of the rotation operation portion by the engaging portion is stabilized.

That is, the flexural deformation of the elastic arm portion, and the elastic deformation of the urging arm absorb the forming error (dimension error) of each of the housing body and the fitting operation lever, and the assembly error of these components, and reduce the variation of the fitting operation force generated due to the forming error and the assembly error of each component. Accordingly, the stable fitting operability can be assured.

### BRIEF DESCRIPTION OF DRAWINGS

FIG. 1 is an exploded perspective view illustrating a lever-type connector according to one embodiment of the invention.

FIG. 2 is an assembly view illustrating the lever-type connector illustrated in FIG. 1, and also a perspective view illustrating a state in which a fitting operation lever is placed at a fitting starting position.

FIG. 3 is a perspective view taken from a rear side of the fitting operation lever illustrated in FIG. 1.

FIG. 4 is a longitudinally cross-sectional view illustrating a state just after the fitting operation lever in the lever-type connector according to the one embodiment is moved to a fitting completion position.

FIG. 5 is an enlarged view illustrating a periphery of a lock portion illustrated in FIG. 4.

FIG. 6 is a longitudinally cross-sectional view illustrating a state in which a rotation operation portion is pressure-contacted with a lock portion by a load due to an urging arm after the fitting operation lever is moved to the fitting completion position in the lever-type connector according to the one embodiment.

FIG. 7 is an enlarged view illustrating the periphery of the lock portion illustrated in FIG. 6.

FIG. 8 is a perspective view illustrating a conventional lever-type connector.

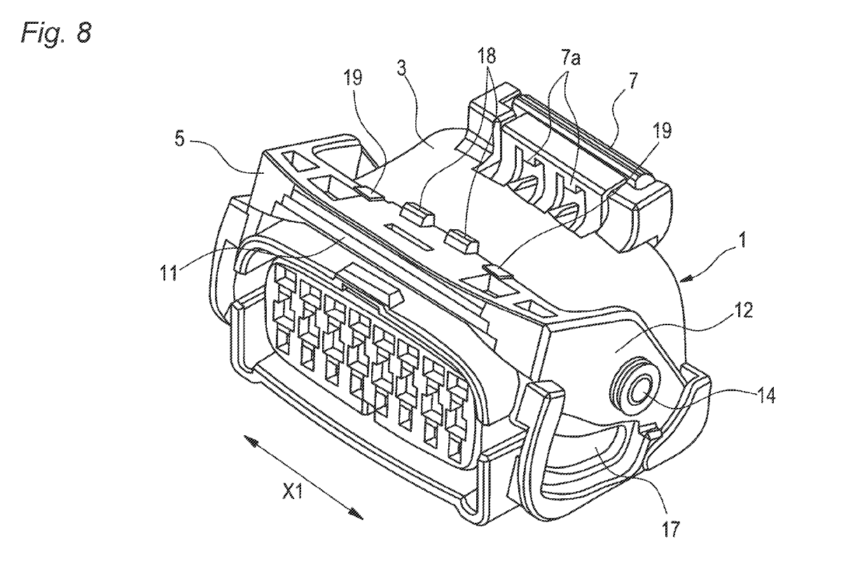

FIG. 9 is a perspective view illustrating a state in which the fitting of the connector illustrated in FIG. 8 to a mating connector housing is completed.

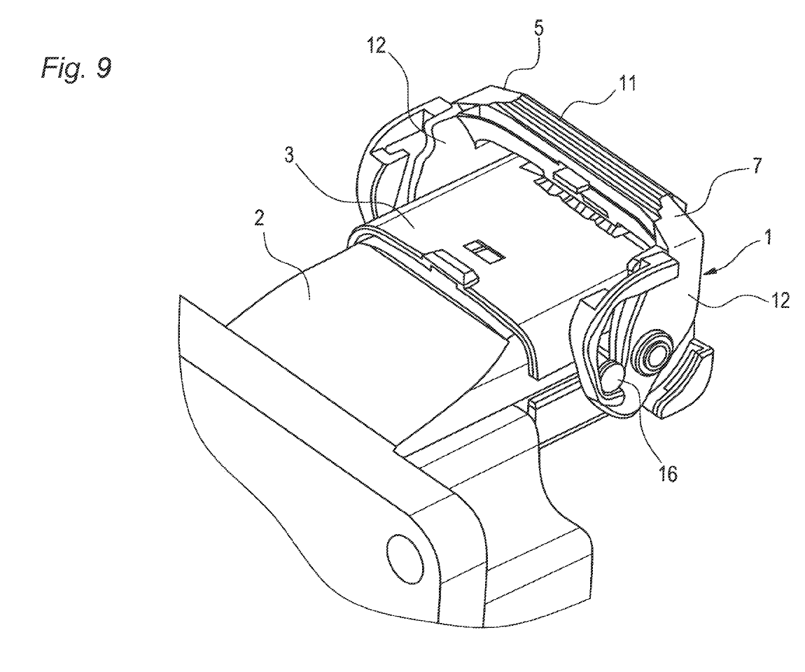

### DESCRIPTION OF EMBODIMENTS

Hereinafter, a preferred embodiment of a lever-type connector according to the invention is described in detail with reference to the drawings.

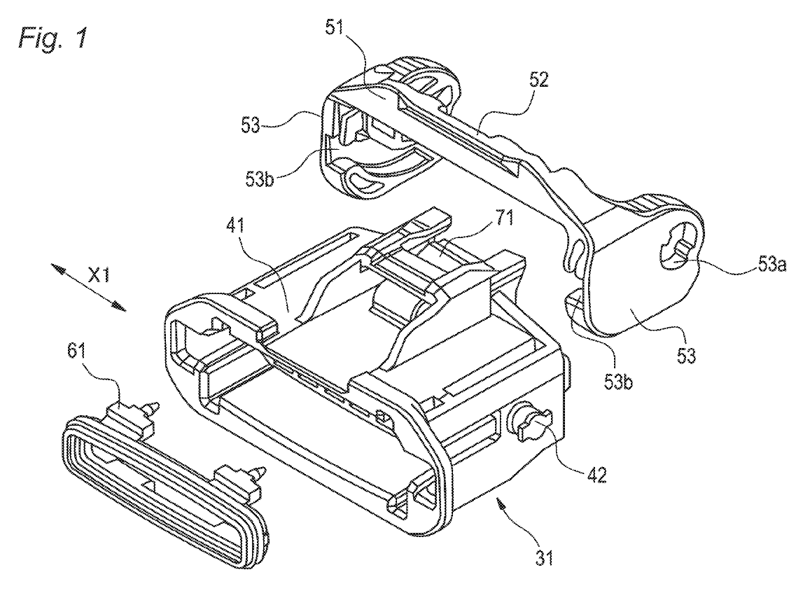

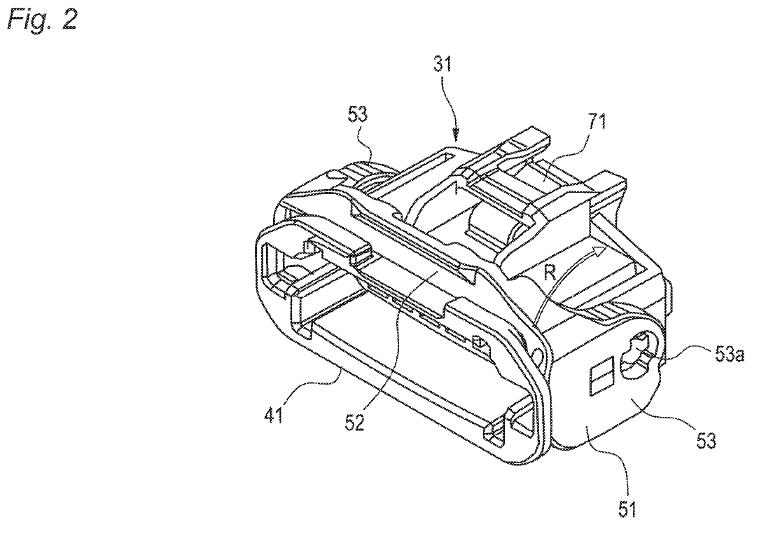

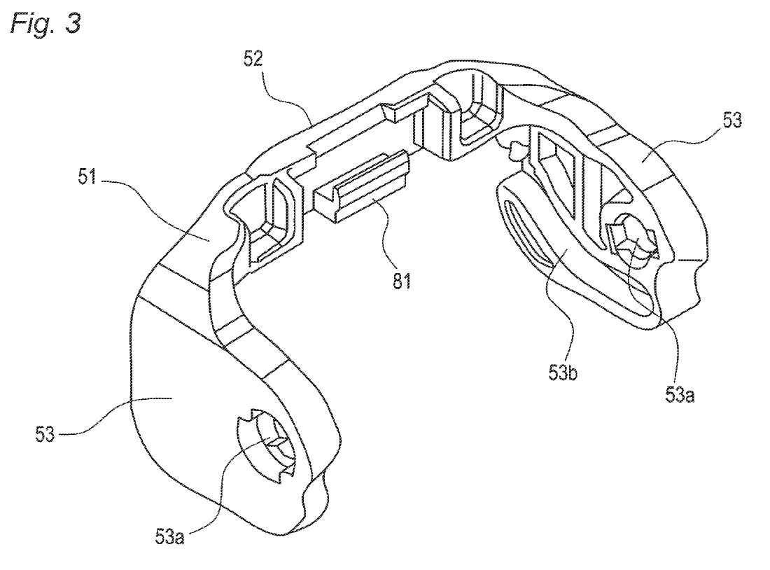

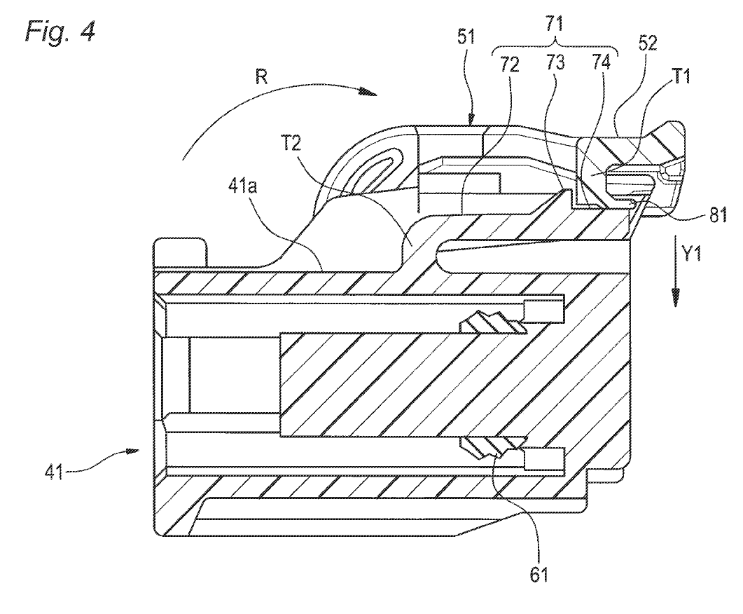

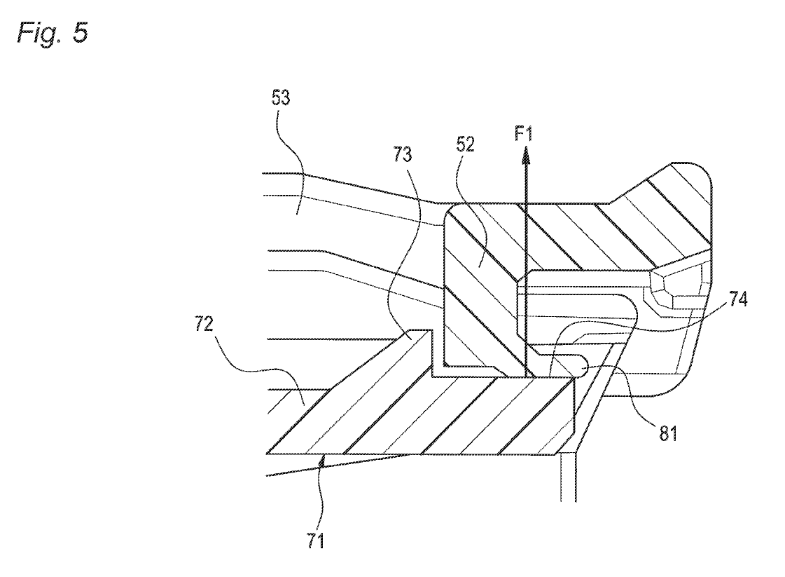

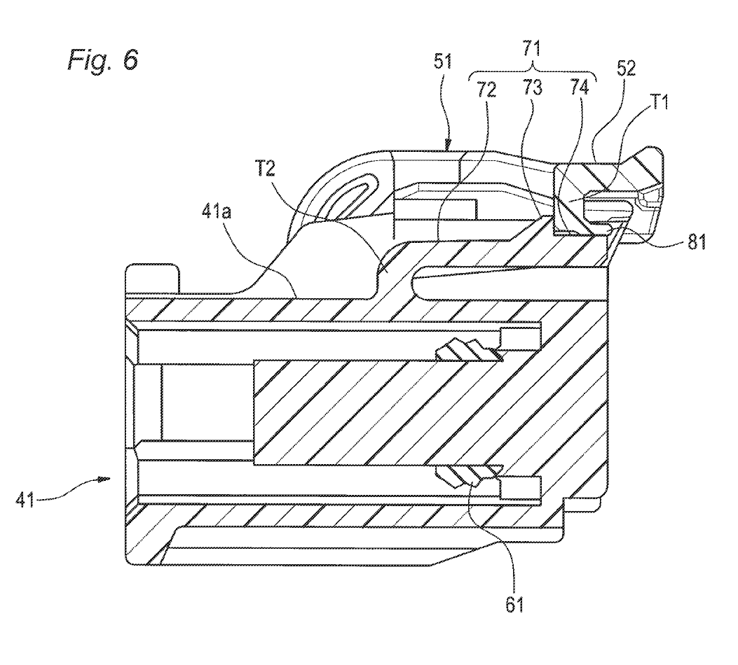

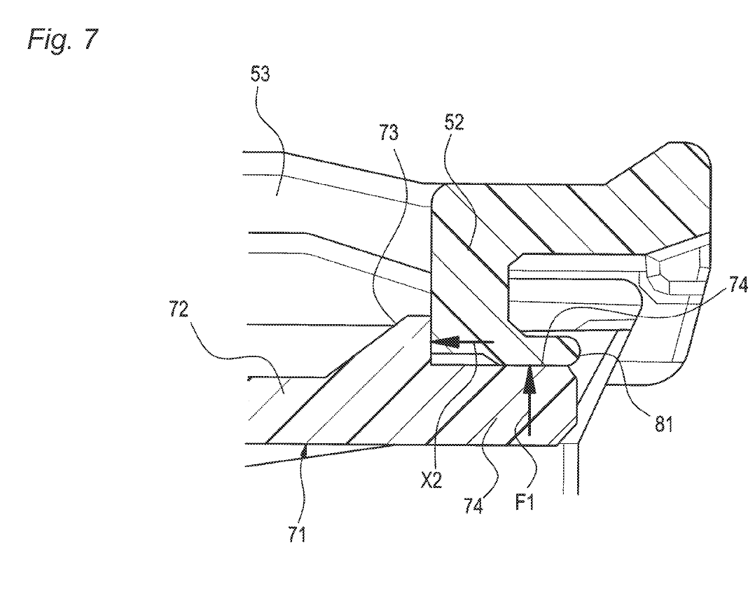

FIGS. 1 to 7 illustrate one embodiment of a lever-type connector according to the invention. FIG. 1 is an exploded perspective view illustrating a lever-type connector according to the one embodiment of the invention. FIG. 2 is an assembly view illustrating the lever-type connector illustrated in FIG. 1, and also a perspective view illustrating a state in which a fitting operation lever is placed at a fitting starting position. FIG. 3 is a perspective view taken from a rear side of the fitting operation lever illustrated in FIG. 1. FIG. 4 is a longitudinally cross-sectional view illustrating a state just after the fitting operation lever in the lever-type connector according to the one embodiment is moved to a fitting completion position. FIG. 5 is an enlarged view illustrating a periphery of a lock portion illustrated in FIG. 4. FIG. 6 is a longitudinally cross-sectional view illustrating a state in which a rotation operation portion is pressure-contacted with a lock portion by a load caused by an urging arm after the fitting operation lever is moved to the fitting completion position in the lever-type connector according to the one embodiment. FIG. 7 is an enlarged view illustrating the periphery of the lock portion illustrated in FIG. 6.

As illustrated in FIG. 1, a lever-type connector 31 according to this one embodiment includes a housing body 41 to be fittingly connected to a mating connector housing (not shown), a fitting operation lever 51 attached to the housing body 41 so as to turn with respect to the housing body 41, a packing 61 attached to the housing body 41 to assure the waterproof property of a fitted portion of each of the housings, a lock portion 71 formed integrally with the housing body 41, and an urging arm 81 (see FIG. 3) formed integrally with the fitting operation lever 51.

The housing body 41 is a resin-molded article and equipped on both outer side surfaces thereof with lever connecting pins 42 to which the fitting operation lever 51 is connected so as to turn with respect to the housing body 41. In addition, the housing body 41 accommodates each connecting terminal (not shown) to be connected to an associated connecting terminal (not shown) in the mating connector housing.

As illustrated in FIGS. 1 and 2, the fitting operation lever 51 includes a rotation operation portion 52 extending in the width direction (i.e., the direction of arrow X1 illustrated in FIG. 1) of the housing body 41, and a pair of lever bodies 53 extending in parallel with each other from both ends of the rotation operation portion 52. Each lever body 53 has a pin fitting hole 53a turnably fitted to an associated one of the lever connecting pins 42. The fitting operation lever 51 can be operated to turn from the fitting starting position (i.e., the position illustrated in FIG. 2) to the fitting completion position (i.e., the position illustrated in FIG. 4) using each of the lever connecting pins 42 provided on both outer side surfaces of the housing body 41 as a turning fulcrum by turnably connecting the lever bodies 53 to the lever connecting pins 42, respectively.

Arrow R illustrated in each of FIGS. 2 and 4 indicates a turning direction when the fitting operation lever 51 is moved from the fitting starting position to the fitting completion position.

As illustrated in FIGS. 1 and 3, in each of the pair of lever bodies 53 of the fitting operation lever 51, a cam groove 53b is formed by notching, each of which an associated one of connecting-bosses respectively provided on both outer side surfaces of the mating connector housing to protrude therefrom can enter. The cam grooves 53b are formed such that when the fitting operation lever 51 is at the fitting starting position illustrated in FIG. 2, each of the connecting bosses enters the starting end of an associated one of the cam grooves 53b, and that when the fitting operation lever 51 is operated to turn to the fitting completion position illustrated in FIG. 4, each of the connecting bosses is drawn into the terminating end of the associated one of the cam grooves 53b, with the progress of turning of the fitting operation lever 51.

Accordingly, the housing body 41 can be fittingly connected to a mating connector housing by an operation of turning the fitting operation lever 51 from the fitting starting position illustrated in FIG. 2 to the fitting completion position illustrated in FIG. 4.

The lock portion 71 is provided on a top surface 41 a of the housing body 41 to protrude therefrom. When the fitting operation lever 51 is moved to the fitting completion position, the lock portion 71 engages the rotation operation portion 52 of the fitting operation lever 51 to thereby fix the fitting operation lever 51, as illustrated in FIG. 4.

In the case of the present embodiment, the lock portion 71 includes an elastic arm portion 72, an engaging portion 73, and an abutting face 74.

The elastic arm portion 72 rises from a position T2 on the outer circumferential surface of the housing body 41 away toward a housing front end from an arrival position T1 (see FIG. 4) which the rotation operation portion 52 reaches when the fitting operation lever 51 is moved to the fitting completion position (i.e., a state illustrated in FIG. 4). In addition, the elastic arm portion 72 extends toward the arrival position T1.

The engaging portion 73 is a retaining protrusion formed integrally with the elastic arm portion 72. The abutting face 74 is a surface of the lock portion 71, against which the rotation operation portion 52 abuts when the rotation operation portion 52 is moved to the arrival position T1, and provided ahead of the engaging portion 73. The abutting face 74 is a positioning surface configured to abut, when the rotation operation portion 52 is moved to the arrival position T1, against the rotation operation portion 52 to thereby maintain the engaging portion 73 and the rotation operation portion 52 in a predetermined positional relation.

The engaging portion 73 engages the rotation operation portion 52 brought into the predetermined positional relation therewith by being moved to the arrival position T1 and abutting against the abutting face 74. Thus, the engaging portion 73 restricts the movement of the rotation operation portion 52.

In the case of the present embodiment, the initial shape and dimensions of the elastic arm portion 72 are set such that the elastic arm portion 72 flexurally deforms when the rotation operation portion 52 engages the engaging portion 73, and that thus, the engaging portion 73 and the rotation operation portion 52 are put into a pressure-contact state.

More specifically, as illustrated in FIG. 4, the elastic arm portion 72 is formed into an upwardly convex arch-like shape. When the rotation operation portion 52 engages the engaging portion 73, the engaging portion 73 engages the rotation operation portion 52 in a state in which a distal end of the elastic arm portion 72 is flexurally displaced by a predetermined dimension in the direction of arrow Y1 illustrated in FIG. 4. The engaging portion 73 and the rotation operation portion 52 are brought into a pressure-contact state by a restoring force generated due to the flexural displacement of the elastic arm portion 72.

The urging arm 81 is formed integrally with the rotation operation portion 52 of the fitting operation lever 51. The urging arm 81 is provided on the rotation operation portion 52 to protrude therefrom such that when the fitting operation lever 51 is moved to the fitting completion position (i.e., the arrival position T1), as illustrated in FIGS. 4 and 5, the urging arm 81 abuts on the abutting face 74 and deforms elastically. The urging arm 81 causes a load F1 (see FIG. 5) in a direction in which the fitting operation lever 51 is returned to the fitting starting position, by the elastic deformation due to the abutment of the urging arm 81 on the abutting face 74, to act upon the rotation operation portion 52. The load F1 is a load in a direction perpendicular to the abutting face 74, which makes a rotational moment in a direction of returning the fitting operation lever 51 to the fitting starting position act upon the fitting operation lever 51.

The fitting operation lever 51 is turned through an arc path around each lever connecting pin 42 with respect to the housing body 41. Thus, a turning behavior due to the load F1 applied from the urging arm 81 causes a displacement in a direction (i.e., a direction indicated by arrow X2 illustrated in FIG. 7) in which the rotation operation portion 52 abuts against the engaging portion 73, as illustrated in FIG. 6. Consequently, the engagement (i.e., the pressure-contact) between the rotation operation portion 52 and the engaging portion 73 is enhanced.

After the position of a mating connector housing is adjusted to the housing body 41 in the lever-type connector 31 according to the above embodiment, the fitting operation lever 51 is turned from the fitting starting position to the fitting completion position. Thus, fitting the housings to each other is completed. Then, the fitting operation lever 51 moved to the fitting completion position is locked by causing the rotation operation portion 52 to engage the engaging portion 73 of the lock portion 71.

When the rotation operation portion 52 of the fitting operation lever 51 engages the engaging portion 73 of the lock portion 71, the elastic arm portion 72 supporting the engaging portion 73 is flexurally deformed, so that the engaging portion 73 and the rotation operation portion 52 are brought into a pressure-contact state.

The flexural deformation of the elastic arm portion 72 not only maintains the pressure-contact state of the engaging portion 73 and the rotation operation portion 52 but absorbs the forming error (i.e., dimension error) of each of the housing body 41 and the fitting operation lever 51, and the assembly error of such components to thereby reduce variation of the fitting operation force, which is caused due to the forming error and the assembly error of each component.

With the configuration according to the one embodiment, when the fitting operation lever 51 is moved to the fitting completion position, so that the rotation operation portion 52 is retained by the retaining portion 73 of the lock portion 71, the urging arm 81 equipped in the rotation operation portion 52 is elastically deformed by abutting against a surface of the lock portion 71. Thus, as illustrated in FIG. 5, the load F1 in a direction of returning the fitting operation lever 51 to the fitting starting position is caused by the urging arm 81 to act upon the rotation operation portion 52.

When the engaging portion 73 and the rotation operation portion 52 are in the pressure-contact state, the load Fl given by the urging arm 81 to the rotation operation portion 52 is applied in the direction of enhancing the pressure-contact between the engaging portion 73 and the rotation operation portion 52. Thus, the pressure-contact force acting between the engaging portion 73 and the rotation operation portion 52 is prevented from becoming insufficient. Consequently, locking the rotation operation portion 52 with the engaging portion 73 is stabilized.

That is, the flexural deformation of the elastic arm portion 72 and the elastic deformation of the urging arm 81 absorb the forming error (dimension error) of each of the housing body 41 and the fitting operation lever 51 and the assembly error of each of such components, and reduce the variation of the fitting operation force, which is caused by the forming error and the assembly error of each component. Thus, stable fitting operability can be assured.

In addition, with the configuration according to the one embodiment, when the engagement between the engaging portion 73 and the rotation operation portion 52 is released by an unlocking operation, the load Fl given by the urging arm 81 to the rotation operation portion 52 pushes the fitting operation lever 51 back to the fitting starting position side. Thus, an operation of releasing the housing body 41 from a mating connector housing can be facilitated. Consequently, treatability can be enhanced.

The above-mentioned embodiment is merely a typical example of the present invention, and the present invention is not limited to the embodiment. That is, the present invention can be variously modified and implemented without departing from the essential features of the present invention.

The lever-type connector according to the invention is not limited to the above embodiment. Appropriate modification and improvement thereof can be made. In addition, the shapes, dimensions, modes, arrangement locations and the like of the lock portion and the fitting operation lever equipped in the housing body can arbitrarily be selected and are not limited to those of the above embodiment, as long as the object of the invention can be achieved.

The present application is based on Japanese Patent Application No. 2011-162467 filed on Jul. 25, 2011, the contents of which are incorporated herein by way of reference.

### INDUSTRIAL APPLICABILITY

According to the lever-type connector of the present invention, the backlash of a lever is prevented, and the variation of the fitting operation force generated due to the forming error and the assembly error is reduced, thereby the fitting operability becomes stable.

### REFERENCE SIGNS LIST

31 Lever-Type Connector
41 Housing Body
42 Lever Connecting Pin
51 Fitting Operation Lever
52 Rotation Operation Lever
53 Lever Body
71 Lock Portion
72 Elastic Arm Portion
73 Engaging Portion
74 Abutting Face
81 Urging Arm

1. A lever-type connector comprising:
a housing body configured to be connected to a mating connector housing;
a fitting operation lever including a rotation operation portion which extends in a width direction of the housing body, and lever bodies which respectively extend from both ends of the rotation operation portion and are connected to both outer side surfaces of the housing body so as to turn with respect to the housing body, wherein the fitting operation lever is configured to be moved from a fitting starting position to a fitting completion position;
a lock portion, provided on the housing body to protrude therefrom, and configured to engage with the rotation operation portion so as to fix the fitting operation lever in a state where the fitting operation lever is positioned at the fitting completion position; and
an urging arm configured to be elastically deformed so as to abut against the lock portion in the state where the fitting operation lever is positioned at the fitting completion position, so that a load is applied to the rotation operation portion in a direction of returning the fitting operation lever to the fitting starting position,
wherein the lock portion includes an elastic arm portion which is extended from an outer surface of the housing body toward an arrival position where the rotation operation portion reaches when the fitting operation lever is moved to the fitting completion position and an engaging portion which is provided on the elastic arm portion and is configured to engage with the rotation operation portion positioned at the arrival position so as to restrict movement of the rotation operation portion, and
wherein an initial shape of the elastic arm portion is set so that the elastic arm portion is deformed so as to put the engaging portion and the rotation operation portion into a pressure-contact state in a state where the rotation operation portion engages the engaging portion.
